(19) United States
(12) Patent Application Publication
(10) Pub. No.: US 2026/0341187 A1
(43) Pub. Date: Oct. 29, 2026

(54) SCOPE TURRET

(71) Applicant: Sheltered Wings, Inc. d/b/a Vortex Optics, Barneveld, WI (US)

(72) Inventors: Robert Morell, Barneveld, WI (US); Dustin Langsdorf, Barneveld, WI (US); Joseph Heltemes, Barneveld, WI (US)

(21) Appl. No.: 19/657,485

(22) Filed: Apr. 24, 2026

Related U.S. Application Data
(60) Provisional application No. 63/794,909, filed on Apr. 25, 2025.

(51) Int. Cl. G09G 3/00; F41G 1/38; F41G 3/08; G09G 3/32

(52) U.S. Cl. CPC G09G 3/035; F41G 1/38; F41G 3/08; G09G 3/32; G09G 2370/06

(57) ABSTRACT

The disclosure relates to a viewing optic. In one embodiment, the disclosure relates to a riflescope comprising a scope body, a movable optical element defining an optical axis connected to the scope body, a turret having a screw defining a screw axis and operably connected to the optical element for changing the optical axis in response to rotation of the screw, and a flexible display containing a first end and a second end, wherein the display is configured for generating an image of graduations for the turret. In another embodiment, the disclosure relates to a method of updating the indicia displayed on a turret.

### CROSS REFERENCE TO RELATED APPLICATIONS

This application is a non-provisional patent application of and claims priority to U.S. Provisional Patent Application No. 63/794,909 filed Apr. 25, 2025, which is incorporated herein by reference in its entirety.

### FIELD

The disclosure relates generally to the field of optic sighting devices. In one embodiment, the disclosure relates to a turret for a riflescope. In one embodiment, the disclosure relates to a riflescope turret with updateable indicia.

### BACKGROUND

A turret is one of several controls on the outside center part of a riflescope body. Turrets are marked in increments and are used to adjust elevation and windage for points of impact change. Conventional turrets have markings on them that indicate how many clicks of adjustment have been dialed in on the turret, or an angular deviation, or a distance compensation for a given cartridge. A click is one tactile adjustment increment on the windage or elevation turret of a scope.

In order to achieve accurate sighting of objects at greater distances, the downward acceleration on the projectile imparted by gravity is of significance. The effect of gravity on a projectile in flight is often referred to as bullet drop because it causes the bullet to drop from the shooter's line of sight. For accuracy at longer distances, the sighting components of a gun must compensate for the effect of bullet drop. An adjustment to the angular position of the riflescope relative to the rifle barrel is made using the elevation turret to compensate for bullet drop.

Similarly, any horizontal forces imparted on the projectile, such as wind, is of significance. The effect of wind on a projectile in flight is often referred to as drift because it causes the bullet to drift right or left from the shooter's line of sight. For accuracy at longer distances, the sighting components of a gun must compensate for the effect of drift. An adjustment to the angular position of the riflescope relative to the axis of the rifle barrel is made using the windage turret to compensate for drift.

Conventional turrets allow for multiple rotations in order to enable the scope to compensate for longer-range targets or environmental conditions such as wind. These turrets typically are marked in units of minutes of angle, or MOA, ( 1/60°) or milliradian, or MRAD ( 1/1000 radian), which correspond to a ratio of drop distance to the longitudinal distance traveled of a bullet. Ballistic turrets may be customized in accordance with known drop data of a given set of ammunition and weather conditions to present units of distance such that quick adjustments may be made by a shooter when using the turret in known, controlled conditions where the distance to the target may change.

Many custom ballistic turrets account for parameters such as the riflescope brand, cartridge type, bullet weight, bullet type, average altitude, average temperature, and the like. However, while ballistic turrets may offer shooters the convenience of easier-to-understand units that may be changed on the fly, a change in shooting conditions through any one or more of the aforementioned parameters may render the custom distance data obsolete. As a result, users of custom ballistic turrets may lose functionality of the turret when hunting or shooting in new environments or incorrectly assume applicability of their existing turret when conditions change. Alternatively, purchasing multiple sets of custom turrets to account for a wide variety of changes in ammunition and/or weather may become costly, as well as be inappropriate for quick replacement when shooting conditions unexpectedly change.

Thus, there exists a need for a riflescope with a turret whose adjustment units may be updated without parts being removed from the riflescope. The apparatuses, systems, and methods disclosed herein address this shortcoming in an innovative fashion.

### SUMMARY

In one embodiment, the disclosure relates to a riflescope comprising: a scope body; a movable optical element defining an optical axis connected to the scope body; a turret having a screw defining a screw axis and operably connected to the optical element for changing the optical axis in response to rotation of the screw; and a flexible display containing a first end and a second end, wherein the display is configured for generating an image of graduations for the turret, wherein the display is wrapped around and removably coupled to the exterior of the turret, and wherein the first end and the second end of the display meet such that the display forms a complete ring.

In one embodiment, the display is in electronic communication with an electronic device, wherein a user may upload parameters to the device to be displayed on the display.

In one embodiment, the electronic device is a mobile phone.

In one embodiment, the parameters are uploaded into an application installed in the mobile phone.

In one embodiment, the turret is an elevation turret.

In one embodiment, the turret is a windage turret.

In one embodiment, the first end and the second end of the display are coupled using an attachment mechanism.

In one embodiment, the first end and the second end of the display are coupled using a clamp.

In one embodiment, the disclosure relates to a riflescope comprising: a scope body; a movable optical element defining an optical axis connected to the scope body; a turret having a screw defining a screw axis and operably connected to the optical element for changing the optical axis in response to rotation of the screw; and a flexible display containing a first end and a second end, wherein the display is configured for generating an image of graduations for the turret, wherein the display is wrapped around and removably coupled to the outer periphery of the turret, and wherein the first end and the second end of the display do not meet such that at least a portion of the exterior of the turret adjacent to the display remains visible.

In one embodiment, at least one indicium is etched into the turret exterior and is visible adjacent to the first end and the second end of the display.

In one embodiment, the zero-point indicium is etched into the turret exterior and is visible adjacent to the first end and the second end of the display.

In one embodiment, the disclosure relates to a riflescope comprising: a scope body; a movable optical element defining an optical axis connected to the scope body; a turret having a screw defining a screw axis and operably connected to the optical element for changing the optical axis in response to rotation of the screw; and a flexible display containing a first end and a second end, wherein the display is configured for generating an image of graduations for the turret, wherein the display is wrapped around and irremovably attached to the exterior of the turret, and wherein the first end and the second end of the display do not meet such that at least a portion of the exterior of the turret adjacent to the display remains visible.

In one embodiment, the disclosure relates to a riflescope comprising: a scope body; a movable optical element defining an optical axis connected to the scope body; a turret having a screw defining a screw axis and operably connected to the optical element for changing the optical axis in response to rotation of the screw; and an angular position encoder comprising one or more photosensors disposed on a ring associated with the turret and configured to read optical markings disposed on an outer circumference of the turret dial to determine the angular position of the turret dial.

In one embodiment, the optical markings are provided in the form of an 8-bit gray code. In one embodiment, the angular position of the turret dial is transmitted wirelessly to a device within a connected ecosystem.

In one embodiment, the disclosure relates to a riflescope comprising: a scope body; a movable optical element defining an optical axis connected to the scope body; a turret having a screw defining a screw axis and operably connected to the optical element for changing the optical axis in response to rotation of the screw; one or more cam curve surfaces disposed on the turret dial; and one or more ultrasonic sensors disposed on a ring associated with the turret and configured to measure a distance to the one or more cam curve surfaces to determine the angular position of the turret dial.

In one embodiment, two or more cam curve surfaces are disposed on the turret dial to provide redundancy in angular position detection.

In one embodiment, the disclosure relates to a riflescope comprising: a scope body; a movable optical element defining an optical axis connected to the scope body; a turret having a screw defining a screw axis and operably connected to the optical element for changing the optical axis in response to rotation of the screw; and a configurable display that is rotationally fixed relative to the turret and oriented toward an eyepiece of the rifle scope, wherein the display is in electronic communication with an encoder associated with the turret.

In one embodiment, the encoder is configured to track the number of revolutions of the turret dial and the display is configured to function as a visual return-to-zero system.

In one embodiment, the display is positioned at the base of the elevation turret.

In one embodiment, the display is positioned at the parallax dial of the riflescope.

In one embodiment, the display is positioned on the saddle of the rifle scope.

In one embodiment, the disclosure relates to a method of updating the indicia displayed on a turret in real-time, comprising: providing data to a mobile application configured to store shooting condition parameters; determining using the mobile application an appropriate range of angular adjustments to be made to scope aim; sending the range of angular adjustments wirelessly to an updateable turret indicator; and displaying the range of angular adjustments in the form of indicia on the updateable turret indicator attached to at least a portion of a riflescope turret, wherein the updateable turret indicator is provided in the form of a flexible display.

In one embodiment, the shooting condition parameters include at least one of a temperature reading, a pressure reading, elevation, wind speed, ammunition type, ammunition weight, and rifle type.

In one embodiment, the range of angular adjustments is provided in units of distance to target.

In one embodiment, the indicia are displayed on the updateable turret indicator in the form of tick marks and numerals.

In one embodiment, the mobile application is installed in a mobile phone.

In one embodiment, the flexible display comprises an LED screen.

In one embodiment, the range of angular adjustments is sent wirelessly to the updateable turret indicator via an NFC antenna.

In one embodiment, the updateable turret indicator is powered wirelessly.

### BRIEF DESCRIPTION OF THE DRAWINGS

FIG. 1A is a schematic depicting parts of a riflescope.

FIG. 1B is a schematic depicting additional parts and components of a viewing optic in accordance with embodiments of the disclosure.

FIG. 1C is a cross-section view of the viewing optic of FIG. 1B showing a moveable optic element inside the optic body.

FIG. 1D is a schematic of a viewing optic depicting a parallax adjustment knob.

FIG. 2A is a side view of an updateable turret indicator with a first indicia range and an electrically linked mobile phone, in accordance with embodiments of the present disclosure.

FIG. 2B is a side view of the updateable turret indicator with a second indicia range and the electrically linked mobile phone, in accordance with embodiments of the disclosure.

FIG. 3 is a perspective view of an embodiment of the updateable turret indicator, in accordance with embodiments of the disclosure.

FIG. 4 is a perspective view of an additional embodiment of the updateable turret indicator, in accordance with embodiments of the disclosure.

FIG. 5 is a side view of an additional embodiment of the updateable turret indicator, in accordance with embodiments of the disclosure.

FIG. 6 is a flowchart representation of a method for updating the indicia displayed on a turret.

FIG. 7 is a schematic of an additional embodiment of the updateable turret indicator incorporating a photosensor-based angular position encoder, in accordance with embodiments of the disclosure.

FIG. 8A is a schematic of an additional embodiment of the updateable turret indicator incorporating ultrasonic sensor-based angular position detection using cam curve surfaces, in accordance with embodiments of the disclosure.

FIG. 8B is a cross-section view of the turret dial of FIG. 8A at the cam curve location depicting the distances measured to determine the angular position of the turret dial.

FIG. 9 is a schematic of an additional embodiment of the updateable turret indicator in the form of a rotationally fixed configurable display positioned at the base of the turret and oriented toward the eyepiece, in accordance with embodiments of the disclosure.

FIG. 10 is a schematic of an alternate version of the embodiment of FIG. 9, wherein the display is positioned at the parallax dial, in accordance with embodiments of the disclosure.

FIG. 11 is a schematic of an alternate version of the embodiment of FIG. 9, wherein the display is positioned on the saddle, in accordance with embodiments of the disclosure.

### DETAILED DESCRIPTION

The apparatuses and methods disclosed herein will now be described more fully hereinafter with reference to the accompanying drawings, in which embodiments of the disclosure are shown. The apparatuses and methods disclosed herein may, however, be embodied in many different forms and should not be construed as limited to the embodiments set forth herein. Rather, these embodiments are provided so that the disclosure will be thorough and complete and will fully convey the scope of the invention to those skilled in the art.

It will be appreciated by those skilled in the art that the set of features and/or capabilities may be readily adapted within the context of a standalone weapons sight, front-mount or rear-mount clip-on weapons sight, and other permutations of filed deployed optical weapons sights. Further, it will be appreciated by those skilled in the art that various combinations of features and capabilities may be incorporated into add-on modules for retrofitting existing fixed or variable weapons sights of any variety.

It will be understood that when an element or layer is referred to as being “on”, “connected to” or “coupled to” another element or layer, it can be directly on, connected or coupled to the other element or layer. Alternatively, intervening elements or layers may be present. In contrast, when an element is referred to as being “directly on,” “directly connected to” or “directly coupled to” another element or layer, there are no intervening elements or layers present.

Like numbers refer to like elements throughout. As used herein, the term “and/or” includes any and all combinations of one or more of the associated listed items.

It will be understood that, although the terms first, second, etc. may be used herein to describe various elements, components, regions, and/or sections, these elements, components, regions, and/or sections should not be limited by these terms. These terms are only used to distinguish one element, component, region, or section from another element, component, region, or section. Thus, a first element, component, region, or section discussed below could be termed a second element, component, region, or section without departing from the disclosure. However, the term a “first focal plane” refers to a focal plane located between the objective lens system and an erector lens system. The term “second focal plane” refers to focal plane near the ocular lens system.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90° or at other orientations) and the spatially relative descriptors used herein interpreted accordingly.

### Definitions

The numerical ranges in this disclosure are approximate and thus may include values outside of the range unless otherwise indicated. Numerical ranges include all values from and including the lower and the upper values, in increments of one unit, provided that there is a separation of at least two units between any lower value and any higher value. As an example, if a compositional, physical or other property, such as, for example, molecular weight, viscosity, etc., is from 100 to 1,000, it is intended that all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, distances from a user of a device to a target.

The term “and/or” as used in a phrase such as “A and/or B” herein is intended to include both A and B; A or B; A (alone); and B (alone). Likewise, the term “and/or” as used in a phrase such as “A, B, and/or C” is intended to encompass each of the following embodiments: A, B, and C; A, B, or C; A or C; A or B; B or C; A and C; A and B; B and C; A (alone); B (alone); and C (alone).

As used herein, an “active display” comprises image-creating pixel modulation. In some instances, the active display is an emissive active display. Emissive active displays, including but not limited to Organic Light-Emitting Diodes (OLED) and Light-Emitting Diodes (LED), feature the image and light source in a single device, and therefore an external light source is not required. This minimizes system size and power consumption, while providing exceptional contrast and color space. OLEDs are made from ultra-thin organic semiconducting layers, which light up when they are connected to voltage (charge carriers become injected and luminance mainly is proportional to the forward current). The major layers comprise several organic materials in sequence (for example, charge transport, blocking and emission layers—each with a thickness of several nanometers), which are inserted between an anode and a cathode. The terms “active display,” “digital display” and “microdisplay” are used interchangeably.

As used herein, an “erector tube” is any structure or device having an opening to receive an erector lens mount.

As used herein, an “erector sleeve” is a protrusion from the erector lens mount which engages a slot in the erector tube and/or cam tube or which serves an analogous purpose. This could be integral to the mount or detachable.

As used herein, a “firearm” is a portable gun, being a barreled weapon that launches one or more projectiles often driven by the action of an explosive force. As used herein, the term “firearm” includes a handgun, a long gun, a rifle, shotgun, a carbine, automatic weapons, semi-automatic weapons, a machine gun, a sub-machine gun, an automatic rifle, and an assault rifle.

As used herein, the term “flood light” refers to a large amount of light provided to a particular area. In some embodiments, the light is provided by one or more light emitting diodes.

As used herein, a “sighting system” refers to one or more optical devices and other systems that assist a person in aiming a firearm or other implement.

As used herein, the term “flexible display system” refers to an integrated display whose physical form may be folded, warped, bent, and/or otherwise manipulated in a manner not possible with a rigid display system. In some instances, the flexible display system has a thickness on the order of the thickness of paper.

As used herein, the term “marks” may comprise any of various visually perceptible lines, circles, dots, cross hairs, horseshoe patterns, geometric shapes, characters, numbers, letters, indicia, or symbols. “Tick marks” may indicate un- or equally spaced vertical lines labeled with numerals.

As used herein, the term “viewing optic” refers to an apparatus used by a shooter or a spotter to select, identify or monitor a target. The “viewing optic” may rely on visual observation of the target, or, for example, on infrared (IR), ultraviolet (UV), radar, thermal, microwave, or magnetic imaging, radiation including X-ray, gamma ray, isotope and particle radiation, night vision, vibrational receptors including ultra-sound, sound pulse, sonar, seismic vibrations, magnetic resonance, gravitational receptors, broadcast frequencies including radio wave, television and cellular receptors, or other image of the target. The image of the target presented to the shooter by the “viewing optic” device may be unaltered, or it may be enhanced, for example, by magnification, amplification, subtraction, superimposition, filtration, stabilization, template matching, or other means. The target selected, identified or monitored by the “viewing optic” may be within the line of sight of the shooter, or tangential to the sight of the shooter, or the shooter's line of sight may be obstructed while the target acquisition device presents a focused image of the target to the shooter. The image of the target acquired by the “viewing optic” may be, for example, analog or digital, and shared, stored, archived, or transmitted within a network of one or more shooters and spotters by, for example, video, physical cable or wire, IR, radio wave, cellular connections, laser pulse, optical, 802.11b or other wireless transmission using, for example, protocols such as html, SML, SOAP, X.25, SNA, etc., Bluetooth™, Serial, USB or other suitable image distribution method. The term “viewing optic” is used interchangeably with “optic sight.”

As used herein, the term “outward scene” refers to a real-world scene, including but not limited to a target.

As used herein, the term “shooter” applies to either the operator making the shot or an individual observing the shot in collaboration with the operator making the shot. The term “shooter” is used interchangeably with “user.”

As used herein, the term “reticle” applies to a circular, planar or flat transparent panel or disk mounted within a scope body in perpendicular relationship to the optical axis or line-of-sight through the scope. The reticle may be positioned between the objective lens element and the erector lens element, typically at a site considered to be a front focal plane of the optical system within the housing. The reticle may contain fine etched lines or hairline indicia comprising a center vertical hairline and a center horizontal hairline, which orthogonally or perpendicularly intersect at a center point.

### Viewing Optic

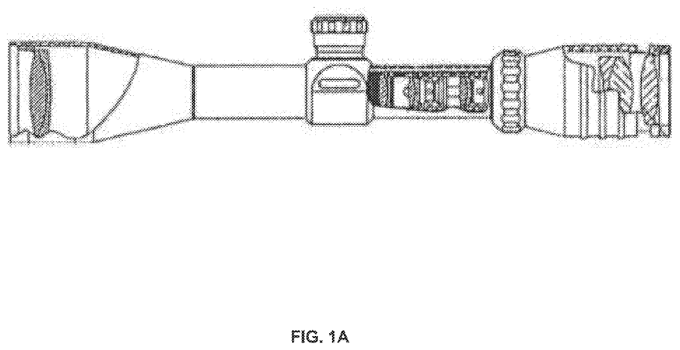

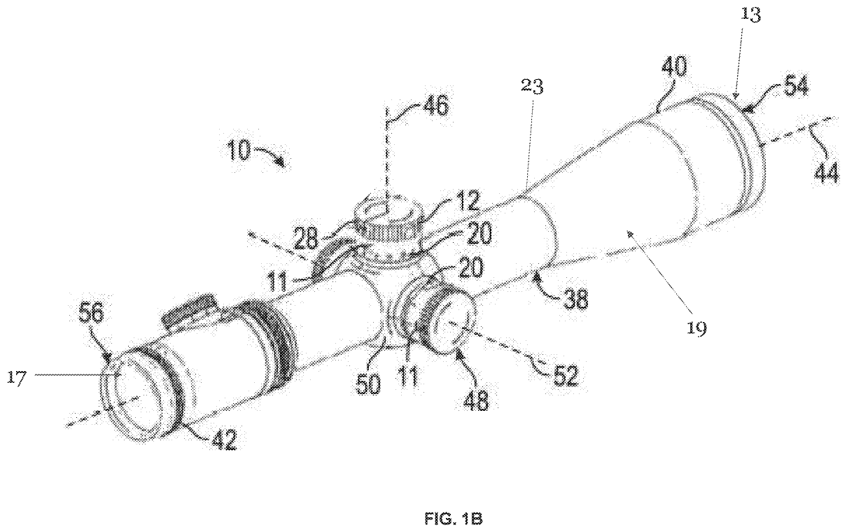

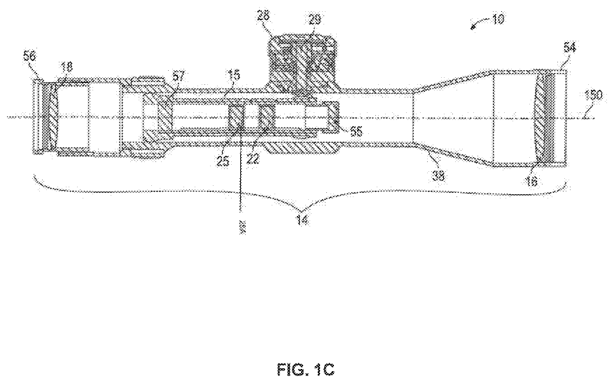

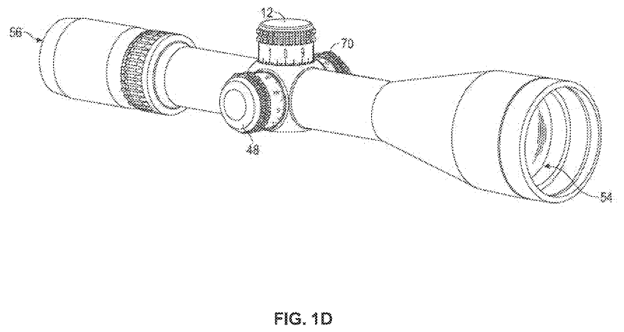

FIG. 1A illustrates a traditional design of a riflescope, which is a representative example of a viewing optic. FIG. 1B illustrates an exemplary viewing optic 10 in accordance with embodiments of the disclosure Specifically, FIG. 1B illustrates a riflescope. The riflescope 10 may be in accordance with the embodiments shown and described in U.S. Pub. No. 2024/0070259, herein incorporated by reference in its entirety. More particularly, the riflescope 10 may comprise a body 38, an eyepiece 56, an objective lens 54, and one or more turrets 12, 48.

The body 38 of the riflescope 10 may enclose a movable optical element 15 in the form of an erector tube. In various embodiments, the scope body 38 is provided in the form of an elongate tube having a larger opening 13 at a front 40 and a smaller opening 17 at a rear 42. A diameter of a cross-section of the front 40 of the scope body 38 may thereby be greater than a diameter of a cross-section of the rear 42 of the body 38. In some cases, an outer surface 19 of the scope body 38 may be smooth such that changes in the diameter of the cross-section of the scope body 38 are continuous. In other cases, the outer surface 19 of the scope body 38 may feature one or more edges, concavities, and/or convexities 23 such that changes in the diameter of the cross-section of the scope body 38 are discrete.

An eyepiece 56 may be attached to the rear 42 of the scope body 38 within the smaller opening 17, and an objective lens 54 may be attached to the front 40 of the scope body 38 within the larger opening 13. The eyepiece 56 may be accessed by a shooter for viewing the external environment, focusing a magnified image provided by the objective lens 54 for viewing. A center axis 44 of the movable optical element 15 may define an optical axis of the riflescope 10. Hence, in some embodiments, a central axis of the objective lens 54, the eyepiece 56, and the scope body 38 may all be collinear.

An elevation turret 12 and/or a windage turret 48 may additionally be coupled to the outside surface 19 of the scope body 38 for points of impact change. The turrets 12, 48 may be provided in the form of dials marked incrementally by indicia 20 on perimeters 11 of the turrets 12, 48. In various instances, the turrets 12, 48 are located at or near the center of the scope body 38. The elevation turret 12 may be rotated to adjust the movable optical element 15 in accordance with an expected vertical movement of a bullet owing to gravity. The windage turret 48 may be rotated to adjust the movable optical element 15 in accordance with an expected horizontal movement of the bullet owing to wind. In some embodiments, the elevation turret 12 is located at a top of the scope body 38 while the windage turret 48 is located on a side of the scope body 38. Thus, in some such embodiments, a rotation axis 46 of the elevation turret 12 is arranged perpendicularly to a rotation axis 52 of the windage turret 48.

In some instances, the turrets 12, 48 may take the shape of cylinders, although in other instances, the turrets may also be provided in other ergonomically rotatable shapes, including but not limited to triangular prisms, cubes, rectangular pyramids, dodecahedrons, etc.

In some cases, the turrets 12, 48 protrude from a turret housing 50 attached to the surface 19 of the scope body 38. The turret housing 50 may be provided in the form of a projection at or near the center of the scope body 38 adding thickness to the outer surface 19. In some such cases, the turret housing 50 encloses an entire revolution around the outer surface 19 of the scope body 38. In other such cases, the turret housing 50 is only provided underneath a bottom surface of the turrets 12, 48 and as such does not enclose an entire revolution around the outer surface 19 of the scope body 38.

In various instances, the turrets 12, 48 provide adjustments in discrete tactile increments (or “clicks”) corresponding to indicia 20 on the outer perimetric surfaces 11 of the turrets 12, 48. The indicia 20 may be provided in the form of tick marks—i.e., equidistant vertical lines etched onto the outer surface of the turrets—and larger tick marks may be added at selected intervals. The tick marks may indicate an amount of rotation required to achieve one click. In various embodiments, the tick marks are assigned one or more numerals indicating an angle of adjustment or distance for bullet drop compensation. For example, in some such embodiments, one click changes the scope's 10 point of impact by 0.1 mrad.

FIG. 1C shows a cross-section view of the sighting device from FIG. 1B with the basic components of an optical system 14 and the moveable optical element 15. As shown in FIG. 1C, optical system 14 may include an objective lens system 16, an erector system 25, and an eyepiece lens system 18. FIG. 1C shows a riflescope having a body 38, but optical system 14 could be used in other types of sighting devices as well. Erector system 25 may be included within a moveable optic element 15. The erector system 25 may include a power varying lens element or zoom element 25A. In FIG. 1C, the moveable optic element 15 may also include a collector 22, as well as a first focal plane reticle 55 and a second focal plane reticle 57. When in use, adjustment of turret assembly 28 and turret screw 29 may cause adjustment of the moveable optic element 15.

The movable optical element 15 may be adjusted by rotating the turret assembly 28 one or more clicks. As the turret is rotated, a turret screw 29 moves in and out of the scope 10, which pushes the erector tube. The erector tube may be biased by a spring so that when the turret screw 29 is adjusted, the turret screw 29 locates the erector tube against the bottom face of the turret screw 29. The erector tube may provide a smaller view of the total image. As the erector tube is adjusted, a position of the reticle may be modified against the image.

In some cases, as shown in FIG. 1D, the viewing optic 10 may include a parallax adjustment knob 70 or a focus knob. Parallax occurs when the optical plane of the image of a target is not coplanar with the optical plane of the image of the reticle. As a result of the offset between the two optical planes, the reticle can appear to move relative to the target when the user moves their eye around the center of the reticle. This parallax error can result in a shift in the point of impact from firing. The parallax adjustment of a viewing optic enables the user to eliminate optical error at different distances, by enabling the optical system to be adjusted to show the image of the target and the image of the reticle in the same optical plane. Parallax compensation changes neither the focus of the reticle nor the focus of the image; it simply moves the planes at which these two objects are in focus so that they share the same plane (are coincident).

As shown in FIG. 1D, the viewing optic 10 may have a side wheel mounted to the rotatable parallax adjustment knob 70. The larger diameter of the side wheel may provide more space for markers, such as range markers, to be applied, and is easier for the user to rotate and read when in use. The larger diameter of the side wheel may also serve to increase the accuracy and resolution of the range finding markers.

### Turret With an Active Display

In various embodiments, the disclosure relates to a viewing optic having an active display that generates a digital image of indicia for one or more turrets. In some embodiments, the active display may replace the indicia etched on the outer surface of the turrets to provide the rotation amount necessary to achieve one click. In another embodiment, the viewing has both a digital image of indica for one or more turrets and etched indicia.

In various embodiments, the disclosure relates to a viewing optic having an active display that is flexible such that the active display may be wrapped around an outer circumference of the one or more turrets. In some instances, the active display is rigidly attached to the one or more turrets, such that the entirety of the etched indicia on the outer surface of the one or more turrets is obscured. In other instances, the active display is removably coupled to the one or more turrets, such that the active display may be slid off the turret when needed.

In various embodiments, the disclosure relates to a viewing optic having an active display whose length is greater than or equal to a circumference of the one or more turrets such that when the active display is wrapped around the outer circumference of the turret, a first end and a second end of the active display meet and may be conjoined by, for example, a clamping or securing mechanism.

In various embodiments, the disclosure relates to a viewing optic having an active display whose length is less than a circumference of the one or more turrets such that when the active display is wrapped around the outer circumference of the turret, a first end and a second end of the active display do not meet, and at least a portion of the etched indicia on the outer surface of the one or more turrets is still visible next to the active display.

In various embodiments, the disclosure relates to a viewing optic having an active display that is in electronic communication with a device that may store parameters relating to one or more environmental or equipment-related conditions that may alter drop distance of ammunition. In some such embodiments, the device may send such data to the active display, enabling the active display to change the indicia provided on the exterior of the turret.

In various embodiments, the disclosure relates to a viewing optic having an active display that is in electronic communication with a phone containing a downloaded application that stores and optionally additionally calculates the one or more environmental or equipment-related conditions that may alter drop distance of ammunition. In some such embodiments, the phone may also provide power to the active display.

Advantageously, the flexible active display may update the indicia displayed on the exterior of the one or more turrets to provide real-time aim correction in a variety of conditions, and more importantly, in circumstances where conditions may rapidly change. Rather than replacing the turret with a new cap reflective of a new set of conditions (i.e., owing to a change in temperature, pressure, elevation, ammunition type, etc.), the shooter may quickly utilize a mobile phone application to transmit data to the flexible active display and display relevant units.

### Flexible Display

In various instances, the active display system is a flexible display. In some embodiments, the flexible display is controlled by a microcontroller or computer. In some such embodiments, the flexible display is controlled by a microcontroller with an integrated graphics controller to output video signals to the display. In additional embodiments, information can be sent wirelessly or via a physical connection into the viewing optic via an NFC antenna. In yet other embodiments, numerous input sources can be input to the microcontroller and displayed on the active display.

In some embodiments, a power source for the flexible display may be physically coupled to the flexible display. In other embodiments, a power source for the flexible display is physically separate from the flexible display.

In various embodiments, the active display can be a reflective, transmissive or an emissive micro-display including but not limited to a micro display, transmissive active matrix LCD display (AMLCD), Organic Light-Emitting Diode (OLED) display, Active Matrix Organic Light-Emitting Diode (AMOLED) display, Light-Emitting Diode (LED) display, e-ink display, a plasma display, a segment display, an electroluminescent display, a surface-conduction electron-emitter display, a quantum dot display, etc.

In various embodiments, the LED array is a micro-pixelated LED array and the LED elements are micro-pixelated LEDs (also referred to as micro-LEDs or μLEDs in the description) having a small pixel size generally less than 75 μm. In some cases, the LED elements may each have a pixel size ranging from approximately 8 μm to approximately 25 μm, and have a pixel pitch (both vertically and horizontally on the micro-LED array) ranging from approximately 10 μm to approximately 30 μm. In some instances, the micro-LED elements have a uniform pixel size of approximately 14 μm (e.g., all micro-LED elements are the same size within a small tolerance) and are arranged in the micro-LED array with a uniform pixel pitch of approximately 25 μm. In some cases, the LED elements may each have a pixel size of 25 μm or less and a pixel pitch of approximately 30 μm or less.

In some embodiments, the micro-LEDs may be inorganic and based on gallium nitride light emitting diodes (GaN LEDs). The micro-LED arrays (comprising numerous μLEDs arranged in a grid or other array) may provide a high-density, emissive micro-display that is not based on external switching or filtering systems. In some cases, the GaN-based, micro-LED array may be grown on, bonded on, or otherwise formed on a transparent sapphire substrate.

In various embodiments, the sapphire substrate is textured, etched, or otherwise patterned to increase the internal quantum efficiency and light extraction efficiency (i.e., to extract more light from the surface of the micro-LEDs) of the micro-LEDs. In other embodiments, silver nanoparticles may be deposited/dispersed on the patterned sapphire substrate to coat the substrate prior to bonding the micro-LEDs to further improve the light efficiency and output power of the GaN-based micro-LEDs and of the micro-LED array.

In various embodiments, the active display can be monochrome or can provide full color, and in some embodiments, can provide multi-color. In other embodiments, other suitable designs or types of displays can be employed. The active display can be driven by electronics. In some instances, the electronics can provide display functions, or can receive such functions from another device in communication therewith.

In various embodiments, the active display can be part of a backlight/display assembly, module or arrangement, having a backlight assembly including a backlight illumination or light source, device, apparatus or member, such as an LED backlight for illuminating the active display with light. In some cases, the backlight source can be a large area LED and can include a first or an integrated lens for collecting and directing generated light to a second, illumination or condenser lens, for collecting, concentrating and directing the light onto active display, along display optical axis B, with good spatial and angular uniformity. The backlight assembly and the active display are able to provide images with sufficient high brightness luminance to be simultaneously viewed with a very high brightness real world view through optics, while being at low power.

The backlight color can be selected to be any monochrome color or can be white to support a full color microdisplay. Other backlight design elements can be included, such as other light sources, waveguides, diffusers, micro-optics, polarizers, birefringent components, optical coatings and reflectors for optimizing performance of the backlight, and which are compatible with the overall size requirements of the active display, and the luminance, power and contrast needs.

Representative examples of micro displays that can be used include but are not limited to: Microoled, including MDP01 (series) DPYM, MDP02, and MDP05; Emagin such as the SVGA, micro-displays with pixel pitches are 9.9×9.9 micron and 7.8×7.8 micron, and Lightning Oled Microdisplay, such as those produced by Kopin Corporation. Micro LED displays can also be used including but not limited to those produced by VueReal and Lumiode.

In various embodiments, the electronics working with the active display can include the ability to generate display symbols, format output for the display, and include battery information, power conditioning circuitry, video interface, serial interface and control features. Other features can be included for additional or different functionality of the display overlay unit. The electronics can provide display functions or can receive such functions from another device in communication therewith.

In various embodiments, the active display can generate images including but not limited to text, alpha-numeric, graphics, symbols, and/or video imagery, icons, etc., including active target reticles, range measurements and wind information, GPS and compass information, firearm inclination information, target finding, recognition and identification (ID) information, and/or external sensor information (sensor video and/or graphics), or images for situational awareness.

In various embodiments, the utilization of an active display allows for a programmable electronic indication of angular adjustment of the field of view. The angular adjustment could be determined by the user or could be calculated based upon information received from a ballistic calculator or ballistic mobile application. This would provide a “drop compensated” aiming point for long range shooting that could be updated on a shot-to-shot interval.

In various embodiments, the active display can be oriented to achieve maximum vertical compensation. In some embodiments, the active display is positioned to be wider than it is tall.

In various embodiments, the integrated display system further comprises a processor in electronic communication with the active display. The integrated display system may further include memory, at least one sensor, and/or an electronic communication device in electronic communication with the processor.

### Mobile Device

In various instances, the flexible display may be in electronic communication with a mobile phone configured to update the flexible display. In some cases, the mobile phone contains a ballistics solver mobile application that is configured to update the flexible display by calculating an angle of adjustment of the riflescope in response to inputted data.

In various embodiments, the application contains one or more widgets configured to allow a user to save environmental data in the ballistics solver mobile application, including but not limited to conditions such as wind speed, elevation, temperature, pressure, humidity, UV index, and other desired parameters. In some instances, the ballistics solver mobile application contains one or more widgets configured to allow a user to save data relating to equipment, including but not limited to conditions such as rifle brand, rifle weight, ammunition type, ammunition weight, ammunition brand, and other desired parameters.

In response to inputted information, the ballistics solver mobile application may calculate an array of drop data corresponding to a range of target distances. The ballistics solver mobile application may utilize any appropriate method to calculate drop data, such as those methods utilized when creating custom ballistic turrets.

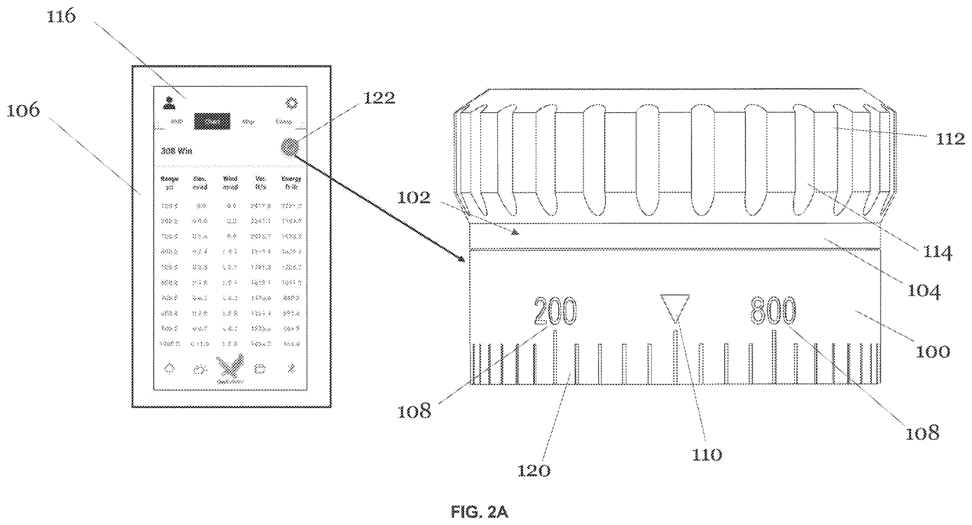

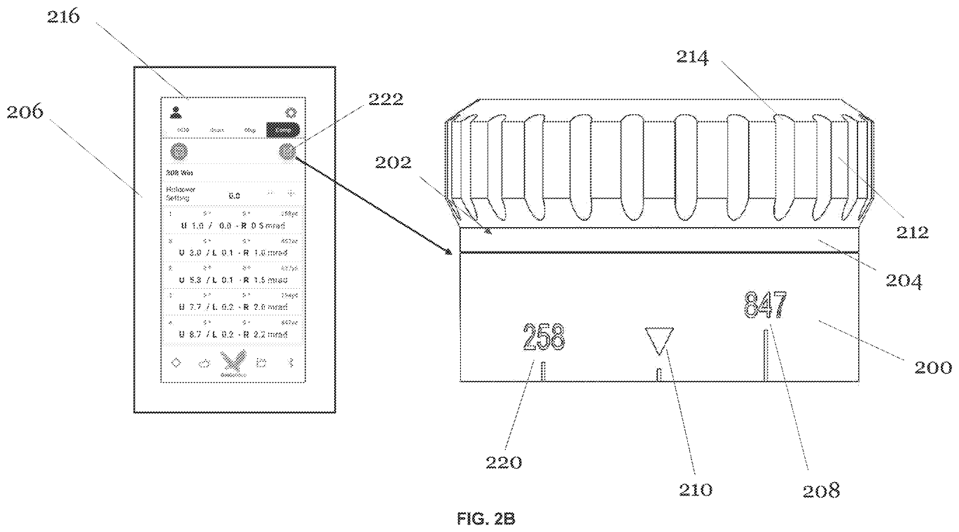

FIGS. 2A and 2B illustrate an example of a flexible display 100 integrated onto the surface 102 of a turret 104 receiving updates from a mobile device 106. In FIG. 2A, the flexible display 100 displays a distance range using numerals 108, with a central marker 110 indicating a zero-point, or starting position of the optic. Exemplary numerals 108 of 200 and 800 yards are provided surrounding the zero-point marker 110. A turret cap 112 above the integrated flexible display 100 includes outer ridges 114 configured to facilitate rotation by providing points of friction for a user's fingers. As the cap 112 is rotated, the integrated display 100 is held fixed on the surface 102. Thus, an angular rotation rate of the flexible display 100 is identical to an angular rotation rate of the turret 104 when the turret 104 is being rotated by the user.

In various instances, the ballistics solver mobile application 116 may update the indicia 120 displayed on the flexible display 100 when a widget or button 122 is selected by the user to send an update to the flexible display 100. In other instances, the ballistics solver mobile application 116 may automatically update the indicia 120 displayed on the flexible display 100 when any saved parameter in the application 116 is changed to reflect a new set of shooting conditions. In yet other instances, the ballistics solver mobile application 116 may automatically update the indicia 120 displayed on the flexible display 100 over a set time interval of the application 116 being open and in use.

For example, as shown in FIG. 2B, the flexible display 200 may alter the numerals 208 and/or tick marks displayed in response to a change in the ballistics solver mobile application 216. As shown, as a result of a change of one or more aforementioned shooting conditions, new numerals 208 of 258 and 847 yards are instead displayed surrounding the central marker 210.

In various embodiments, the ballistics solver mobile application 216 may allow for a user to completely customize the images presented by the flexible display 200. For example, in FIG. 2B, tick marks of unequal sizes are used to indicate the clicks required to reach 258 and 847 yards. While atypical of a custom ballistic turret featuring etched tick marks, this customization may offer users the benefit of comprehensive control over the information conveyed by the exterior 202 of the turret 204. For example, in some embodiments, a user may elect to increase the length of the tick mark for 847 yards as shown owing to a routine hunting exercise at a distance of 847 yards from the target.

In certain cases, the ballistics solver mobile application 216 may include features to load pre-used or pre-loaded yardage ranges to the flexible display 200. For example, a user may save typical target distances in the ballistics solver mobile application 216 to quickly access a desired range of distance corrections to be sent to the flexible display 200. The ballistics solver mobile application 216 may also be downloaded with example target distances consistent with those that would be commonly used when creating a conventional turret with markings.

In various embodiments, the mobile device 206 may interact with the flexible display 200 via a wireless receiver, such as an NFC antenna. Installation of the flexible display 200 on the turret 204 connects the display 200 to contacts (not shown) that maintain contact with rotation of the turret 204 and lead back to a printed circuit board (PCB). This PCB may contain the hardware required to perform an NFC update.

In some embodiments, the active display may update after a time delay, defined as a difference in the time between data having been sent from the ballistics solver mobile application 216 to the flexible display 200. In certain embodiments, the time delay may be between about 1 second and about 1 minute, although the time delay may be somewhat less than or even greater than these values. In other embodiments, the time delay is no more than 5 minutes, no more than 3 minutes, no more than 2 minutes, no more than 45 seconds, no more than 30 seconds, no more than 25 seconds, no more than 20 seconds, no more than 10 seconds, or no more than 5 seconds. In some such embodiments, the time delay may fall within a range bounded by any minimum value and any maximum value as described above.

### Turret Indicator

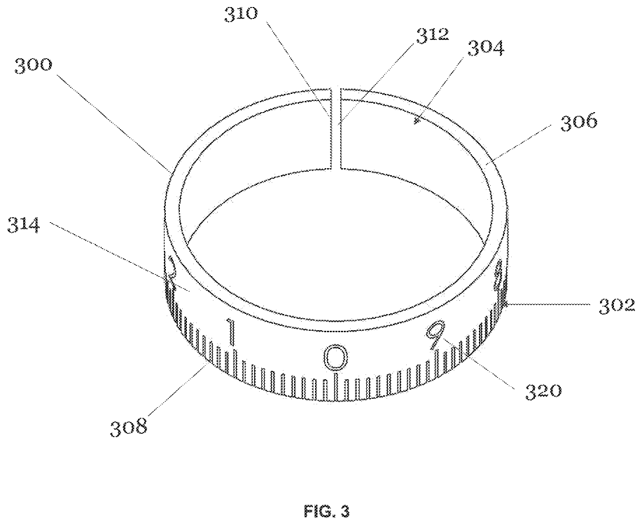

FIG. 3 displays a first embodiment of the updateable turret indicator 300 in the form of a ring. As shown, the updateable turret indicator 300 may comprise at least an outer surface 302 including a display 314, an inner surface 304, a top edge 306, a bottom edge 308, a first end 310, and a second end 312. In some instances, such as that shown in FIG. 3, the first end 310 and the second end 312 of the updateable turret indicator 300 are perpendicular to the top edge 306 and the bottom edge 308 such that the updateable turret indicator 300 takes the shape of a right cylinder. In some such instances, the outer surface 302 is in the shape of a rectangle when the updateable turret indicator 300 is unwrapped, i.e., when the first end 310 and the second end 312 are separated.

In other instances, the first end 310 and the second end 312 may be slanted with respect to the top edge 306 and the bottom edge 308. In yet other instances, the first end 310 and the second end 312 may feature any one or more of curves, bumps, sharp edges, concavities, and convexities. In some such instances, the first end 310 and the second end 312 may include complementary features configured to mate upon contact. For example, the first end 310 may feature a projection where the second end 312 features a recession.

In various embodiments, the first end 310 and the second end 312 of the updateable turret indicator 300 are irremovably coupled such that the updateable turret indicator 300 may not be unwrapped. The first end 310 and the second end 312 may be adhered using any available means included but not limited to welding, gluing, and soldering.

In various embodiments, the outer surface 302 of the updateable turret indicator 300 comprises, consists essentially of, or consists of a display 314. The display 314 may be comprised of flexible material and may be folded, warped, bent, and/or otherwise manipulated in conjunction with movement of the updateable turret indicator 300.

In some embodiments, the updateable turret indicator 300 may then be slid through a perimeter of a turret (not shown) on a riflescope in order to replace the indicia present on the outer surface of the turret. The updateable turret indicator 300 may be irremovably attached to the outer perimeter of the turret such that no portion of the etched indicia on the turret is visible. The updateable turret indicator 300 may be adhered to the turret using any available means included but not limited to welding, gluing, and soldering. The updateable turret indicator 300 may thereby rotate coincidentally with rotation of the turret.

The indicia 320 on the surface 302 of the updateable turret indicator 300 may have any length, thickness, color, and brightness in accordance with settings selected by the user in a ballistics solver mobile application. For example, in some embodiments, the indicia 320 contain both major and minor increments. In certain embodiments, the updateable turret indicator 300 may display a “zero-point”, indicating that the turret has not been rotated.

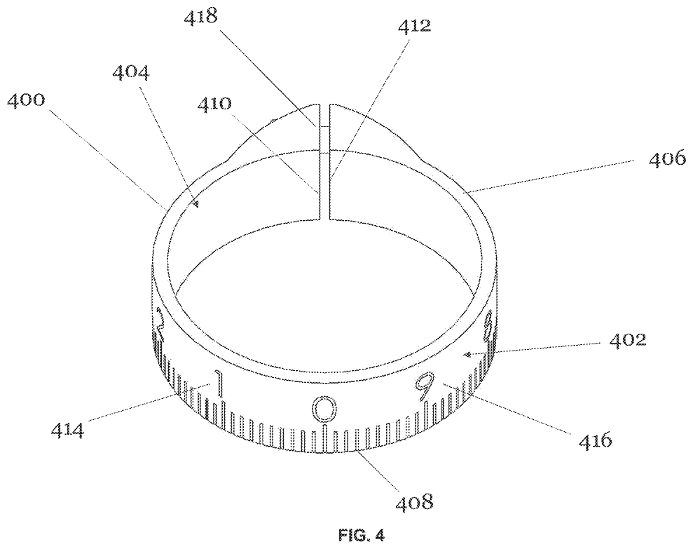

In additional embodiments, an updateable turret indicator 400 may be removed and replaced when desired by the user. FIG. 4 illustrates a second embodiment of the updateable turret indicator 400 in the form of a ring. The updateable turret indicator 400 may appear substantially similar to and contain substantially similar elements as the updateable turret indicator 300; however, the updateable turret indicator 400 may additionally feature an attachment mechanism to temporarily couple the updateable turret indicator 400 to the exterior of the turret.

In some embodiments, the attachment mechanism may be provided in the form of a mechanical clamp 418 such as that shown in FIG. 4. In other embodiments, the attachment mechanism may be provided in the form of an adhesive strip that mates the inner surface 404 of the updateable turret indicator 400 with the exterior of the turret. Examples of such an adhesive strip include but are not limited to magnetic strips, hook-and-loop strips, strips containing a tacky surface, and glue strips.

In certain embodiments, the updateable turret indicator 400 may be integral to the turret—i.e., the turret may be manufactured with the updateable turret indicator 400. In some such instances, the turret and the updateable turret indicator 400 may act as modular components of a larger riflescope assembly.

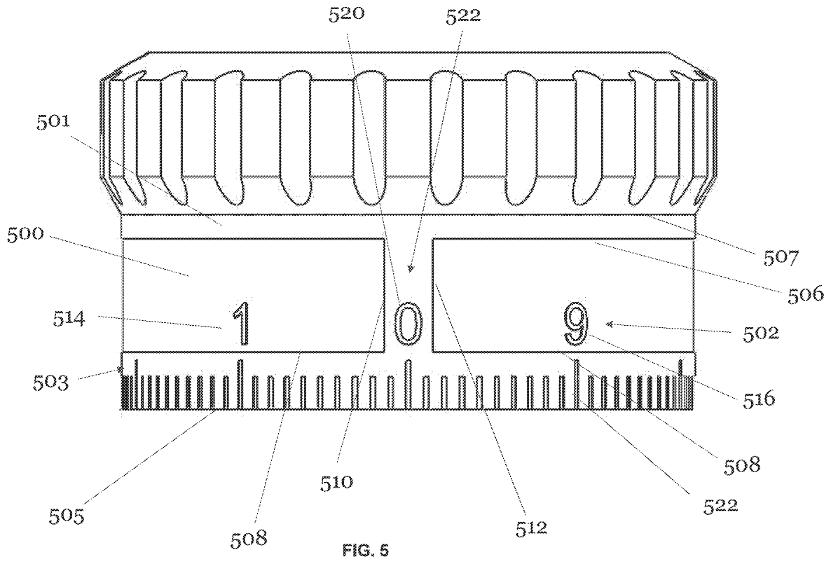

In various embodiments, such as in FIG. 5, the updateable turret indicator 500 may not form a complete ring when wrapped around an exterior 503 of a turret 501. In some such embodiments, a gap 522 is present between the first end 510 and the second end 512 such that at least a portion of the exterior 503 of the turret 501 is visible adjacent to the updateable turret indicator 500.

In some instances, the gap 522 allows for etched indicia 520 on the exterior 503 of a turret 501 to be visible to the user. Any portion of the indicia 520—such as the tick marks, numerals 516, or both—may remain readable next to the updateable turret indicator 500. In various embodiments, the zero-point of the turret 501 may remain uncovered by the updateable turret indicator 500 to indicate no rotation of the turret 501.

The gap 522 may be of any length. For example, in some cases, an arcuate length of the gap 522 may be between about 1% and about 25% of the circumference of the turret 501, although the arcuate length of the gap 522 may be somewhat less than or even greater than these values. In other cases, an arcuate length of the gap 522 is at least 1%, or at least 2%, or at least 3%, or at least 4%, or at least 5%, or at least 7%, or at least 10% of the circumference of the turret 501. In some such embodiments, the arcuate length of the gap 522 is no more than about 25% of the circumference of the turret 501. In some embodiments, the arcuate length of the gap 522 may fall within a range bounded by any minimum value and any maximum value as described above.

A width of the updateable turret indicator 500, defined as the distance between the top edge 506 and the bottom edge 508 (and, in various embodiments, the length of the first end 510 and the second end 512) may additionally be tuned by the user to allow for as large or small of coverage of the exterior 503 of the turret 501 as desired. In the embodiment shown in FIG. 5, for example, tick marks of the indicia 520 are visible below the updateable turret indicator 500, thereby displaying a consistent graduation scale regardless of the numerical values 516 displayed and updated by the updateable turret indicator 500. Thus, in some instances, the updateable turret indicator 500 may be pasted onto the exterior 503 of the turret 501 such that the bottom edge 508 of the updateable turret indicator 500 is contiguous with a bottom edge 505 of the turret 501. In other instances, the updateable turret indicator 500 may instead or additionally be pasted onto the exterior 503 of the turret 501 such that the top edge 506 of the updateable turret indicator 500 is contiguous with a top edge 507 of the turret 501. In yet other instances, the updateable turret indicator 500 may instead or additionally be pasted onto the exterior 503 of the turret 501 such that neither end 506, 508 is contiguous with ends 505, 507 of the turret 501.

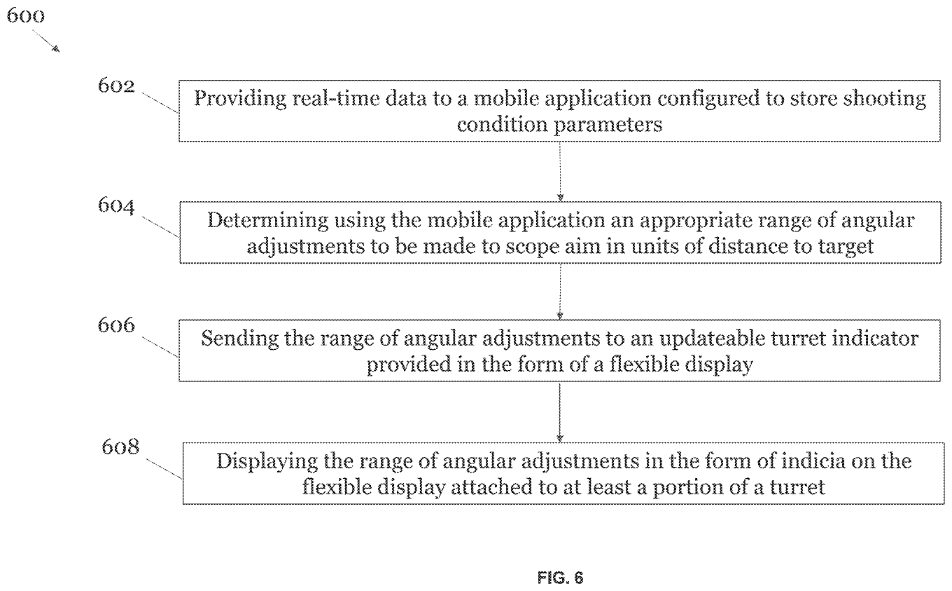

Turning to FIG. 6, a method 600 for updating the indicia displayed on a turret in real-time is provided. The method 600 may include a step 602 of providing real-time data to a mobile application configured to store shooting condition parameters. The shooting condition parameters may include one or more of temperature, pressure, elevation, and wind readings, as well as ammunition type, rifle type, and the like. The shooting parameters may be provided to the mobile application either in anticipation of such conditions, such as prior to reaching a hunting or shooting destination, or may be provided to the mobile application while at the hunting or shooting destination. Advantageously, one or more of the shooting condition parameters may be updated directly after a change in a shooting condition. For example, a temperature reading may be uploaded to the mobile application directly after an increase or a decrease in outside temperature.

The method 600 may include a step 604 of determining using the mobile application an appropriate range of angular adjustments to be made to scope aim in units of distance to target. The mobile application may in certain instances determine the adjustments to be made upon an input command by the user, such as via a widget or button within the mobile application. In other instances, the mobile application may automatically determine the adjustments to be made upon any change in the uploaded shooting conditions.

In various instances, the mobile application may feature an integrated ballistics solver or a ballistics calculator to determine the range of angular adjustments to be made.

The method 600 may include a step 606 of sending the range of angular adjustments to an updateable turret indicator provided in the form of a flexible display. In some cases, the turret indicator is a substantially cylindrical display that may be wrapped around an existing turret of a riflescope. In some such cases, the turret indicator may be removably coupled to the turret. In other such cases, the turret indicator may be irremovably coupled to the turret.

In certain instances, the turret indicator may cover a substantial portion of the turret. In additional instances, the turret indicator may cover an incomplete portion of the turret such that etch marks on the exterior of the turret remain visible to the user.

The mobile application may in various embodiments send the range of angular adjustments to the turret indicator via an NFC antenna.

The method 600 may include a step 606 of displaying the range of angular adjustments in the form of indicia on the flexible display attached to at least a portion of a turret. The user may as a result be able to quickly adjust for bullet drop over a range of distances when one or more shooting parameters change in real-time.

### Photosensor-Based Angular Position Encoder

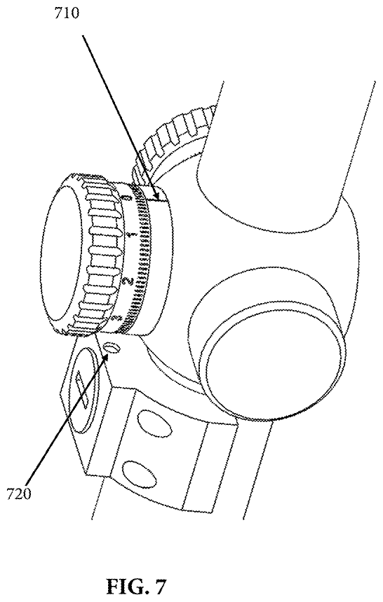

In one embodiment, as depicted in FIG. 7, the updateable turret indicator may incorporate an angular position sensing system configured to determine and transmit the rotational position of the turret dial. In one embodiment, tape-applied or etched turret dial markings are disposed on the outer circumference of the turret dial and are configured to interface with one or more photosensors. The one or more photosensors may be embedded within a forward upper portion of the ring of the updateable turret indicator.

In certain embodiments, the turret dial markings are provided in the form of an 8-bit gray code pattern 710 disposed around the outer circumference of the turret dial. The 8-bit gray code pattern may provide an angular resolution of approximately 1.4° per increment. The use of a gray code, as opposed to a standard binary code, may advantageously minimize positional errors during transitions between adjacent angular positions. In one embodiment, the pattern can be encoded such that one bit changes between consecutive code value.

In one embodiment, the 8-bit gray code is absolute encoding. In another embodiment, the 8-bit gray code is incremental encoding.

In one embodiment, the one or more photosensors read the gray code markings as the turret dial is rotated and convert the optical information into a digital signal representing the absolute angular position of the turret dial. In one embodiment, the photosensors 720 may be positioned in the forward upper ring half such that they maintain consistent optical contact with the turret dial markings across the full range of turret rotation.

In one embodiment, the determined angular position of the turret dial may be transmitted to one or more devices within a connected system. Such devices may include, without limitation, a mobile phone, a ballistics solver mobile application, a display device, or any other electronic device in electronic communication with the updateable turret indicator. The transmission may occur via a wireless communication protocol, including but not limited to NFC, Bluetooth, or Wi-Fi. In some such embodiments, the transmitted position data enables the connected device or application to display, log, or process the angular adjustment dialed in by the user in real time.

In one embodiment, this design is not specific to any particular turret SKU and may be adapted for use with a wide variety of existing turret dial configurations. The tape-applied or etched gray code markings may be applied to or formed on any turret dial having a suitable outer circumferential surface to receive the markings. Accordingly, this embodiment may be provided as an aftermarket addition to an existing riflescope turret or may be manufactured as an integral component of the turret assembly.

### Ultrasonic Sensor-Based Angular Position Encoder

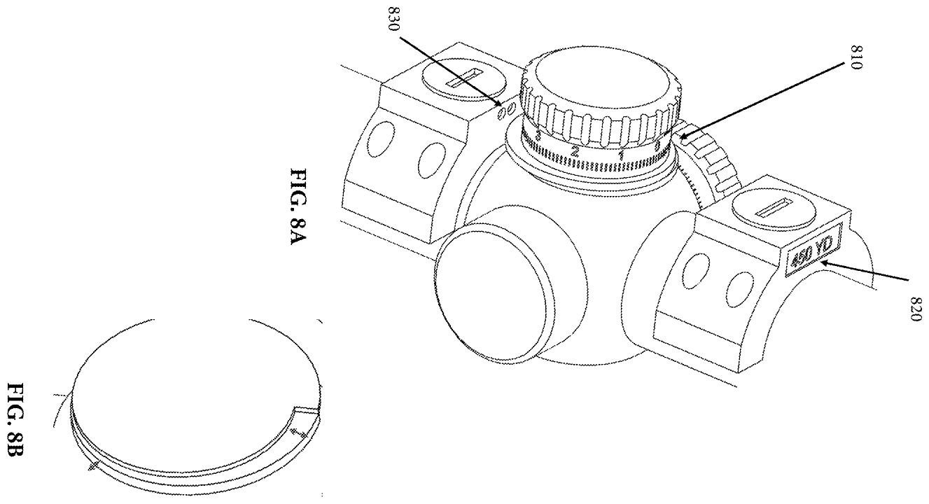

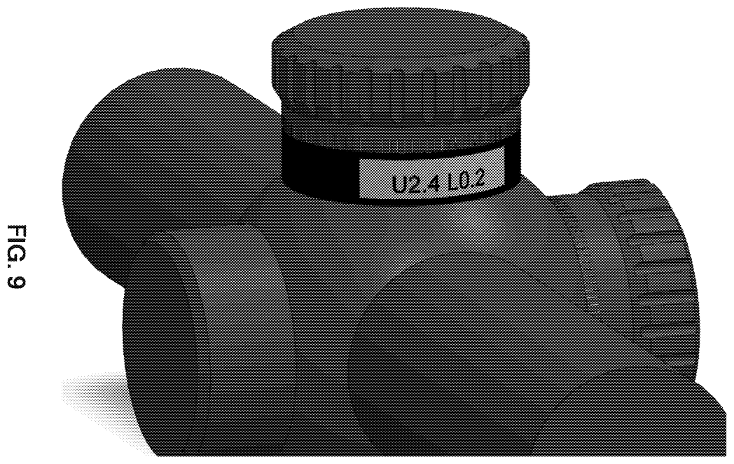

In various embodiments, as depicted in FIGS. 8A and 8B, the updateable turret indicator may incorporate an angular position sensing system utilizing one or more ultrasonic sensors in conjunction with one or more raised cam curve surfaces disposed on the turret dial. In some such embodiments, the one or more ultrasonic sensors 830 are embedded within an upper ring half of the updateable turret indicator and are oriented to face the outer or lateral surface of the turret dial.

In one embodiment, one or more raised cam curve surfaces 810 are provided on the turret dial. The relative location of the raised cam curve surfaces with respect to one another defines the radial and angular position of the turret dial. As the turret dial is rotated, the distance measured by the one or more ultrasonic sensors 830 between the sensor and the raised cam curve surface changes in a predictable, predetermined manner. The angular position of the turret dial may then be derived from the measured distance data and transmitted to a display 820. In some embodiments, the cam curve profile is specifically contoured such that each angular position of the turret dial corresponds to a unique distance measurement or combination of distance measurements.

In one embodiment, two or more raised cam curve surfaces are employed on the turret dial to provide redundancy and increased tolerance with respect to the placement of the ring on the turret assembly. By measuring distances to multiple cam curve surfaces simultaneously or in sequence, the system may compensate for variations in ring mounting position and thereby improve the accuracy and repeatability of angular position detection.

In one embodiment, as illustrated in FIG. 8B, a cross-sectional view of the turret dial at the cam curve location depicts the distances measured by the ultrasonic sensor(s) to determine the angular position of the turret dial. The measured distances may be processed by a microcontroller or processor associated with the updateable turret indicator to calculate the precise angular position of the turret.

In various embodiments, the determined angular position of the turret dial may be transmitted to one or more devices within the connected ecosystem, including but not limited to a mobile phone, a ballistics solver application, or an external display. As with the photosensor embodiment described above, transmission may be accomplished via a wireless communication protocol. In some embodiments, the rear upper ring half may additionally or alternatively house the sensor package, thereby removing the need for an embedded sensing system in the forward upper ring half.

In various embodiments, this embodiment is also not specific to any particular turret SKU, and the cam curve surfaces may be applied to or formed on a wide variety of existing turret dial configurations, either as an integral manufacturing feature or as an aftermarket modification.

### Rotationally Fixed Configurable Display

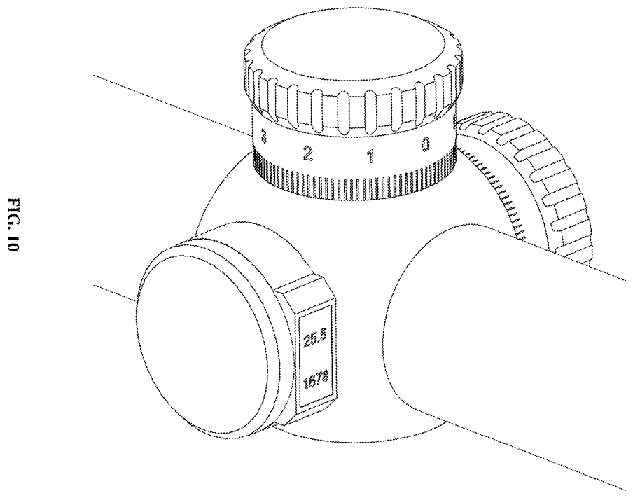

In various embodiments, as depicted in FIG. 9, the disclosure relates to an updateable turret indicator provided in the form of a configurable display that is rotationally fixed relative to the turret and oriented toward the eyepiece and user.

In one embodiment, the rotationally fixed display is disposed at or near the base of the elevation turret. The display may be mounted to the turret housing or to the outer surface of the scope body such that it does not rotate when the turret dial is actuated. In one embodiment, the display faces rearward, toward the eyepiece, such that the shooter may read the displayed information while looking through or in the direction of the eyepiece without repositioning the firearm.

In one embodiment, the elevation turret and/or the windage turret may include one or more encoders configured to detect the rotational position of the respective turret dial. The encoders may be in electronic communication with the rotationally fixed display such that the display presents the current angular adjustment or distance compensation corresponding to the detected position of the turret dial. In some embodiments, the encoder may be of the type described in the photosensor-based embodiment or the ultrasonic sensor-based embodiment set forth above, or may be any other suitable encoder type.

In certain embodiments, the rotationally fixed display and the associated encoder(s) are configured to track and display the cumulative number of turret revolutions. This capability may be particularly advantageous when the turret is a multi-revolution turret, as it enables the user to maintain an accurate count of the total angular adjustment dialed in across multiple rotations. In some such embodiments, the display may additionally function as a visual return-to-zero system, providing the user with a clear indication of the number of additional rotations required to return the turret to its zero-point position.

In certain embodiments, the display may present information including, but not limited to, the current angular adjustment in units of MOA or MRAD, the estimated distance to target based on the current turret position and loaded ballistic parameters, the number of turret revolutions from zero, and an indication of the return-to-zero direction.

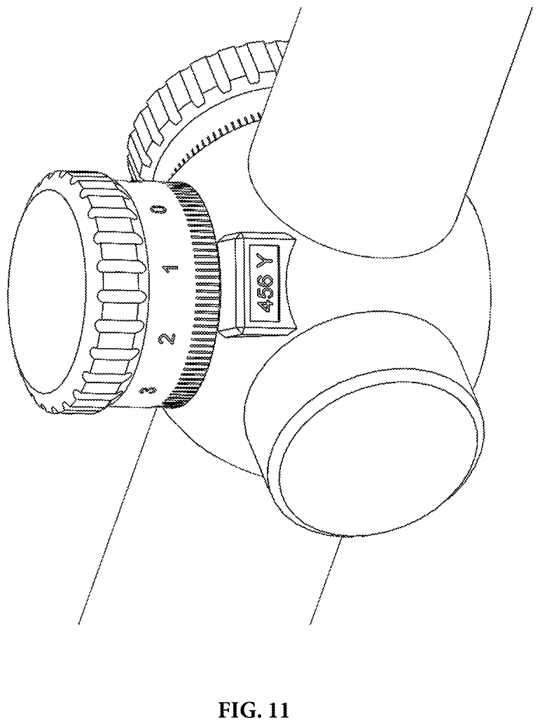

In another embodiment, as depicted in FIG. 10, the configurable display may be positioned at the parallax dial rather than at the base of the elevation turret. In this configuration, the display is disposed on or adjacent to the parallax adjustment knob of the viewing optic. The positioning of the display at the parallax dial may advantageously reduce the overall height of the elevation dial assembly, which may be desirable in applications where a lower profile turret configuration is preferred, such as when reduced obstruction of the field of view or compatibility with certain mounting systems is required.

In some embodiments, the display positioned at the parallax dial may remain in electronic communication with the elevation and/or windage turret encoder(s), such that the angular adjustment information for the elevation and/or windage turrets is still conveyed to the user via the parallax-dial-mounted display. Alternatively or in addition, the display may convey parallax adjustment information, providing the user with a combined readout of multiple scope parameters at a single, accessible location.

In another embodiment, as depicted in FIG. 11, the configurable display may be positioned on the saddle of the riflescope. As used herein, the “saddle” refers to the central body region of the riflescope housing from which the turret housings project. In this configuration, the display is mounted on the outer surface of the saddle and may be oriented to face upward, laterally, or rearward as desired by the user or manufacturer.

In certain embodiments, the saddle-mounted display may remain in electronic communication with the elevation and/or windage turret encoder(s), providing the user with a readout of the current angular adjustment for one or both turrets from the central body of the scope. The saddle-mounted configuration may be advantageous in certain deployment scenarios, as the saddle provides a relatively large, stable mounting surface for the display and positions the readout in a location that may be accessible to both a primary shooter and a spotter. In some embodiments, the saddle-mounted display may be a rigid display, as the relatively flat or gently curved surfaces of the saddle may not necessitate a flexible display substrate.

The disclosure may be further described by the following paragraphs:

A riflescope comprising: a scope body; a movable optical element defining an optical axis connected to the scope body; a turret having a screw defining a screw axis and operably connected to the optical element for changing the optical axis in response to rotation of the screw; and a flexible display containing a first end and a second end, wherein the display is configured for generating an image of graduations for the turret, wherein the display is wrapped around and removably coupled to the exterior of the turret, and wherein the first end and the second end of the display meet such that the display forms a complete ring.

A riflescope of any of the preceding paragraphs, wherein the display is in electronic communication with an electronic device, wherein a user may upload parameters to the device to be displayed on the display.

A riflescope of any of the preceding paragraphs, wherein the electronic device is a mobile phone.

A riflescope of any of the preceding paragraphs, wherein the parameters are uploaded into an application installed in the mobile phone.

A riflescope of any of the preceding paragraphs, wherein the turret is an elevation turret.

A riflescope of any of the preceding paragraphs, wherein the turret is a windage turret.

A riflescope of any of the preceding paragraphs, wherein the first end and the second end of the turret are coupled using an attachment mechanism.

A riflescope of any of the preceding paragraphs, wherein the first end and the second end of the turret are coupled using a clamp.

A riflescope comprising: a scope body; a movable optical element defining an optical axis connected to the scope body; a turret having a screw defining a screw axis and operably connected to the optical element for changing the optical axis in response to rotation of the screw; and a flexible display containing a first end and a second end, wherein the display is configured for generating an image of graduations for the turret, wherein the display is wrapped around and removably coupled to the outer periphery of the turret, and wherein the first end and the second end of the display do not meet such that at least a portion of the exterior of the turret adjacent to the display remains visible.

A riflescope of any of the preceding paragraphs, wherein at least one indicium is etched into the turret exterior and is visible adjacent to the first end and the second end of the display.

A riflescope of any of the preceding paragraphs, wherein the zero-point indicium is etched into the turret exterior and is visible adjacent to the first end and the second end of the display.

A riflescope comprising: a scope body; a movable optical element defining an optical axis connected to the scope body; a turret having a screw defining a screw axis and operably connected to the optical element for changing the optical axis in response to rotation of the screw; and a flexible display containing a first end and a second end, wherein the display is configured for generating an image of graduations for the turret, wherein the display is wrapped around and irremovably attached to the exterior of the turret, and wherein the first end and the second end of the display do not meet such that at least a portion of the exterior of the turret adjacent to the display remains visible.

A riflescope comprising: a scope body; a movable optical element defining an optical axis connected to the scope body; a turret having a screw defining a screw axis and operably connected to the optical element for changing the optical axis in response to rotation of the screw; a ring disposed about the turret comprising one or more photosensors; and optical markings disposed on an outer circumference of the turret dial and configured to interface with the one or more photosensors to determine an angular position of the turret dial.

A riflescope of any of the preceding paragraphs, wherein the optical markings are provided in the form of an 8-bit gray code.

A riflescope of any of the preceding paragraphs, wherein the angular position of the turret dial is transmitted wirelessly to at least one device.

A riflescope of any of the preceding paragraphs, wherein the one or more photosensors are embedded in a forward upper portion of the ring.

A riflescope comprising: a scope body; a movable optical element defining an optical axis connected to the scope body; a turret having a screw defining a screw axis and operably connected to the optical element for changing the optical axis in response to rotation of the screw; one or more cam curve surfaces disposed on the turret dial; and one or more ultrasonic sensors disposed on a ring associated with the turret and configured to measure a distance to the one or more cam curve surfaces to determine an angular position of the turret dial.

A riflescope of any of the preceding paragraphs, wherein two or more cam curve surfaces are disposed on the turret dial.

A riflescope of any of the preceding paragraphs, wherein the angular position of the turret dial is transmitted wirelessly to at least one device.

A riflescope of any of the preceding paragraphs, wherein the one or more ultrasonic sensors are embedded in an upper ring half.

A riflescope comprising: a scope body; a movable optical element defining an optical axis connected to the scope body; a turret having a screw defining a screw axis and operably connected to the optical element for changing the optical axis in response to rotation of the screw; and a configurable display rotationally fixed relative to the turret and oriented toward an eyepiece of the rifle scope, wherein the display is in electronic communication with an encoder associated with the turret.

A riflescope of any of the preceding paragraphs, wherein the encoder is configured to track a number of revolutions of the turret dial.

A riflescope of any of the preceding paragraphs, wherein the display is configured to function as a visual return-to-zero system.

A riflescope of any of the preceding paragraphs, wherein the display is positioned at the base of the elevation turret.

A riflescope of any of the preceding paragraphs, wherein the display is positioned at a parallax dial of the rifle scope.

A riflescope of any of the preceding paragraphs, wherein the display is positioned on a saddle of the rifle scope.

A riflescope of any of the preceding paragraphs, wherein the encoder is in electronic communication with at least one of an elevation turret and a windage turret.

A method of updating the indicia displayed on a turret comprising: providing data to a mobile application configured to store shooting condition parameters; determining using the mobile application an appropriate range of angular adjustments to be made to scope aim; sending the range of angular adjustments wirelessly to an updateable turret indicator; and displaying the range of angular adjustments in the form of indicia on the updateable turret indicator attached to at least a portion of a riflescope turret, wherein the updateable turret indicator is provided in the form of a flexible display.

A method of any of the preceding paragraphs, wherein the shooting condition parameters include at least one of a temperature reading, a pressure reading, elevation, wind speed, ammunition type, ammunition weight, and rifle type.

A method of any of the preceding paragraphs, wherein the range of angular adjustments is provided in units of distance to target.

A method of any of the preceding paragraphs, wherein the indicia are displayed on the updateable turret indicator in the form of tick marks and numerals.

A method of any of the preceding paragraphs, wherein the mobile application is installed in a mobile phone.

A method of any of the preceding paragraphs, wherein the flexible display comprises an LED screen.

A method of any of the preceding paragraphs, wherein the range of angular adjustments is sent wirelessly to the updateable turret indicator via an NFC antenna.

A method of any of the preceding paragraphs, wherein the updateable turret indicator is powered wirelessly.

A riflescope substantially as shown and described herein.

A turret substantially as shown and described herein.

A flexible display substantially as shown and described herein.

It is to be understood that the steps of the above method may comprise more or fewer steps in accordance with the principles of the disclosure. Certain steps may also occur concurrently, in a different order, or iteratively as a result of a change in multiple parameters. For example, a user may elect to provide data to the mobile application over multiple segments prior to calculating the new range of angular adjustments to be made. In an additional case, a user may not upload a new set of shooting conditions to update the turret indicator and may instead select a set of preloaded angular adjustments to be sent to the turret indicator in anticipation of shooting conditions.

While multiple embodiments of the updateable turret indicator and corresponding ballistics solver mobile application have been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A riflescope comprising:
a scope body;
a movable optical element defining an optical axis connected to the scope body;
a turret having a screw defining a screw axis and operably connected to the optical element for changing the optical axis in response to rotation of the screw; and
a flexible display containing a first end and a second end,
wherein the display is configured for generating an image of graduations for the turret,
wherein the display is wrapped around and removably coupled to the exterior of the turret, and
wherein the first end and the second end of the display meet such that the display forms a complete ring.

2. The riflescope of claim 1, wherein the display is in electronic communication with an electronic device, and further wherein a user may upload parameters to the device to be displayed on the display.

3. The riflescope of claim 2, wherein the electronic device is a mobile phone.

4. The riflescope of claim 3, wherein the parameters are uploaded into an application installed in the mobile phone.

5. The riflescope of claim 1, wherein the turret is an elevation turret.

6. The riflescope of claim 1, wherein the turret is a windage turret.

7. The riflescope of claim 1, wherein the first end and the second end of the display are coupled using an attachment mechanism.

8. The riflescope of claim 7, wherein the first end and the second end of the display are coupled using a clamp.

9. A riflescope comprising:
a scope body;
a movable optical element defining an optical axis connected to the scope body;
a turret having a screw defining a screw axis and operably connected to the optical element for changing the optical axis in response to rotation of the screw; and
a flexible display containing a first end and a second end,
wherein the display is configured for generating an image of graduations for the turret,
wherein the display is wrapped around and removably coupled to the outer periphery of the turret, and
wherein the first end and the second end of the display do not meet such that at least a portion of the exterior of the turret adjacent to the display remains visible.

10. The rifle scope of claim 9, wherein at least one indicium is etched into the turret exterior and is visible adjacent to the first end and the second end of the display.

11. The rifle scope of claim 10, wherein the zero-point indicium is etched into the turret exterior and is visible adjacent to the first end and the second end of the display.

12. A method of updating the indicia displayed on a turret comprising:
providing data to a mobile application configured to store shooting condition parameters;
determining using the mobile application an appropriate range of angular adjustments to be made to scope aim;
sending the range of angular adjustments wirelessly to an updateable turret indicator; and
displaying the range of angular adjustments in the form of indicia on the updateable turret indicator attached to at least a portion of a riflescope turret,
wherein the updateable turret indicator is provided in the form of a flexible display.

13. The method of claim 12, wherein the shooting condition parameters include at least one of a temperature reading, a pressure reading, elevation, wind speed, ammunition type, ammunition weight, and rifle type.

14. The method of claim 12, wherein the range of angular adjustments is provided in units of distance to target.

15. The method of claim 12, wherein the indicia are displayed on the updateable turret indicator in the form of tick marks and numerals.

16. The method of claim 12, wherein the mobile application is installed in a mobile phone.

17. The method of claim 12, wherein the flexible display comprises an LED screen.

18. The method of claim 12, wherein the range of angular adjustments is sent wirelessly to the updateable turret indicator via an NFC antenna.

19. The method of claim 12, wherein the updateable turret indicator is powered wirelessly.
